(19) United States
(12) Patent Application Publication
(10) Pub. No.: US 2013/0140303 A1
(43) Pub. Date: Jun. 6, 2013

(54) SHIPPING CONTAINER AND INSERT FOR THE SAME

(71) Applicants: Mark James, Chattanooga, TN (US); Shawn Edens, Calhoun, GA (US)

(72) Inventors: Mark James, Chattanooga, TN (US); Shawn Edens, Calhoun, GA (US)

(21) Appl. No.: 12/582,220

(22) Filed: Oct. 20, 2009

Related U.S. Application Data
(60) Provisional application No. 61/106,692, filed on Oct. 20, 2008.
(60) Provisional application No. 61/216,621, filed on May 19, 2009.

(51) Int. Cl. B65D 88/00; B65B 1/04; B31B 1/26; B65D 5/42; B65D 81/02

(52) U.S. Cl. 220/1.5; 229/126; 206/521; 493/162; 53/473

(57) ABSTRACT

A storage apparatus for shipping one or more articles is disclosed as well as a way of manufacturing the storage apparatus and shipping articles with the storage apparatus. The storage apparatus includes a main panel that includes at least two opposing flaps. The opposing flaps extend away from outside edges of the main panel and include an overlay portion and a folding portion. One or more tabs are included on the corners of the storage apparatus and are configured to bend upwardly to engage sidewalls of a storage container.

### CROSS-REFERENCE TO RELATED APPLICATIONS

This application claims the benefit of the filing date of Provisional Application No. 61/106,692 filed on Oct. 20, 2008, and Provisional Application No. 61/216,621 filed on May 19, 2009, which are incorporated herein by reference in their entirety.

### BACKGROUND

The present invention relates generally to shipping containers and, more particularly, to an insert for a shipping container that is configured and operable to securely and safely hold in position one or more fragile or semi-fragile shipping articles.

Shipping some types of relatively flat articles can be somewhat complicated when one or more of the articles need to be safely, yet securely, shipped to a destination. These articles could be tile, flooring, mirrors, and other types of fragile or semi-fragile articles. During shipment, the articles must be maintained in a relatively secure position to prevent damage of the articles. The present invention discloses an insert that may be used for a shipping container that is configured to securely and safely ship one or more relatively flat articles.

### SUMMARY

One aspect of the present invention discloses a shipping apparatus that includes a main panel that, in one form, is generally rectangular in shape. The main panel includes at least two opposing flaps that are movably connected with the main panel. The flaps include an overlay portion that extends inwardly toward a plurality of flap fold lines. The flap fold lines are operable to allow the flaps to bend to wrap around an article to be shipped. In one form, the fold lines end within an interior portion of the main panel. The flap fold lines allow the flaps to wrap around one or more articles such that a portion of the flap fold lines is proximate to a side surface of the articles and the overlay portion is proximate to an upper surface of the articles.

Another aspect of the present invention discloses a method of manufacturing a storage apparatus. The method includes the step of forming a main panel, which may be manufactured from cardboard or other suitable packaging material. A plurality of flaps is also formed in the main panel at least a portion of which extends outwardly from an outside sidewall portion of the main panel. A plurality of fold or score lines are formed in the flaps and extend from an overlay portion of the flaps toward the main panel. The fold lines allow the flaps to wrap around at least a portion of one or more articles positioned on top of the main panel.

The present invention also discloses a method of packaging one or more articles, such as tile, hardwood flooring, mirrors, and the like. The method includes the step of placing one or more articles stacked on top of one another on a main panel of an insert. At least two opposing flaps extending away from an outside sidewall of the main panel are then bent or folded in such a manner that an overlay portion of the flaps is proximate an upper portion of the stacked articles and a folding portion of the flaps is proximate a side surface of the stacked articles. The insert may then be placed within a storage container, such as a card board box for example, for shipment.

Further, additional features and advantages are realized through the techniques of the present invention. Other embodiments and aspects of the invention are described in detail herein and are considered a part of the claimed invention.

### BRIEF DESCRIPTION OF THE DRAWINGS

FIG. 1 is a plan view of one embodiment insert for a shipping container.

FIG. 2 is a plan view of another embodiment insert for a shipping container.

FIG. 3 is a plan view of another embodiment insert for a shipping container.

FIG. 4 is a plan view of a top pad usable with the inserts of FIGS. 1-3.

FIG. 5 is a section view taken across the tabs of the insert with articles stacked thereon within a shipping container and showing the tabs of the insert folded to fit within the container and the flaps folded to secure the articles to the insert.

FIG. 6 is a partial section view showing one folding arrangement for the scoring lines on for the flaps of the insert relative to the articles stacked on the insert.

FIG. 7 is a perspective view of a shipping container.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended, and that alterations and further modifications to the illustrated devices and/or further applications of the principles of the invention as illustrated herein are contemplated as would normally occur to one skilled in the art to which the invention relates.

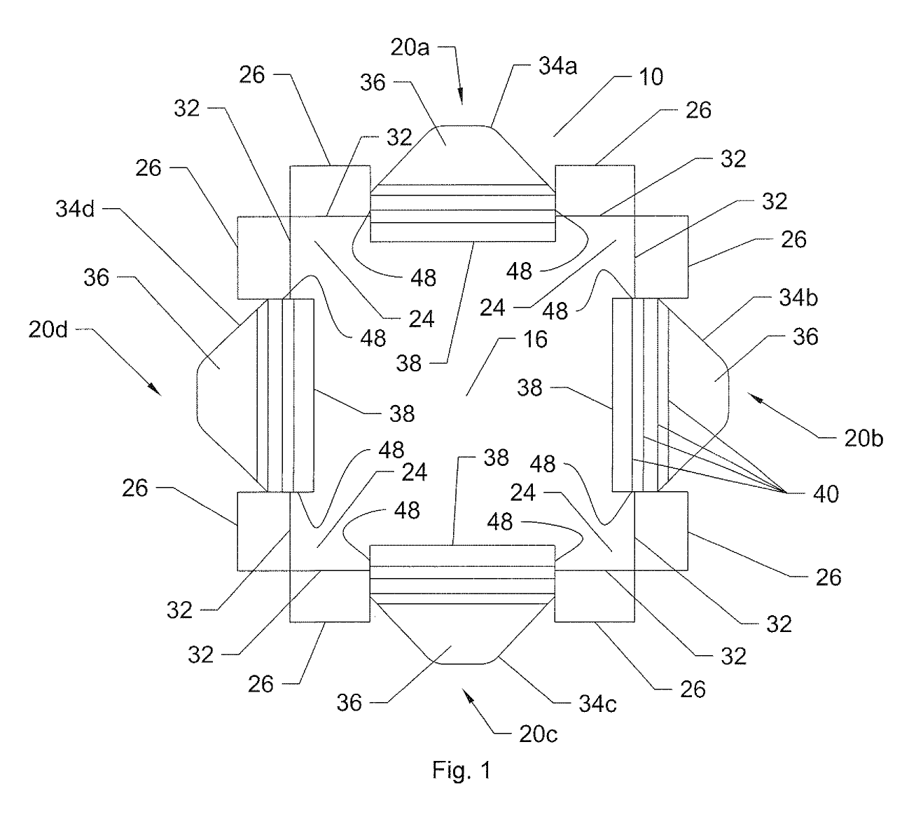

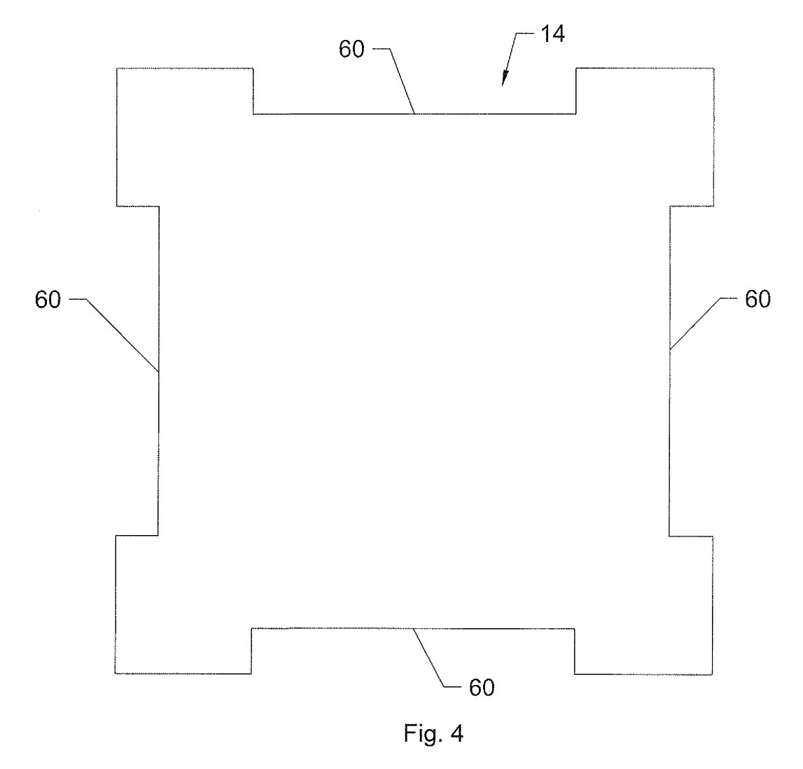

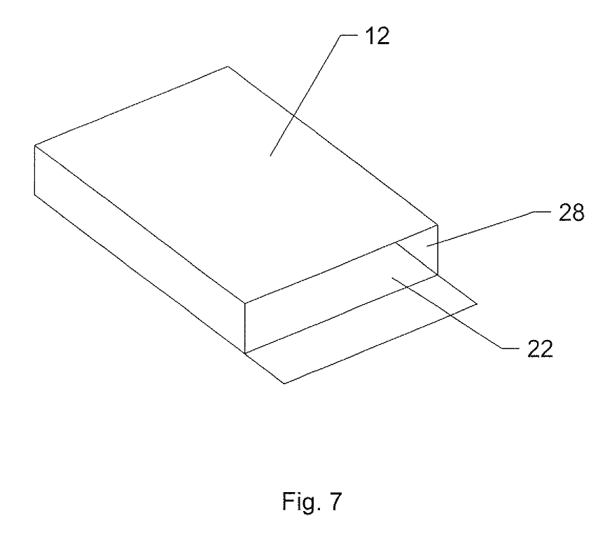

An insert 10 for a shipping container 12 is disclosed that is used for shipping articles to to prevent damage of the articles. The insert 10 is typically made from cardboard and is used in a cardboard box type shipping container 12 to maintain, for example, hardwood or tile flooring samples in position within the box during shipment. However, it is contemplated that the insert 10 may be made from materials other than cardboard, and that the insert 10 and shipping container 12 may be used to ship articles other than hardwood flooring and tile flooring samples. The insert 10 is modular in that it can be modified to accommodate articles of different sizes while allowing the same size shipping container to be used to ship articles of different sizes. FIGS. 1-3 show various embodiments of inserts 10, while FIG. 4 shows an upper protective panel 14 that sits on top of the flooring samples after the samples are positioned within the insert 10. FIG. 7 shows one embodiment of a shipping container.

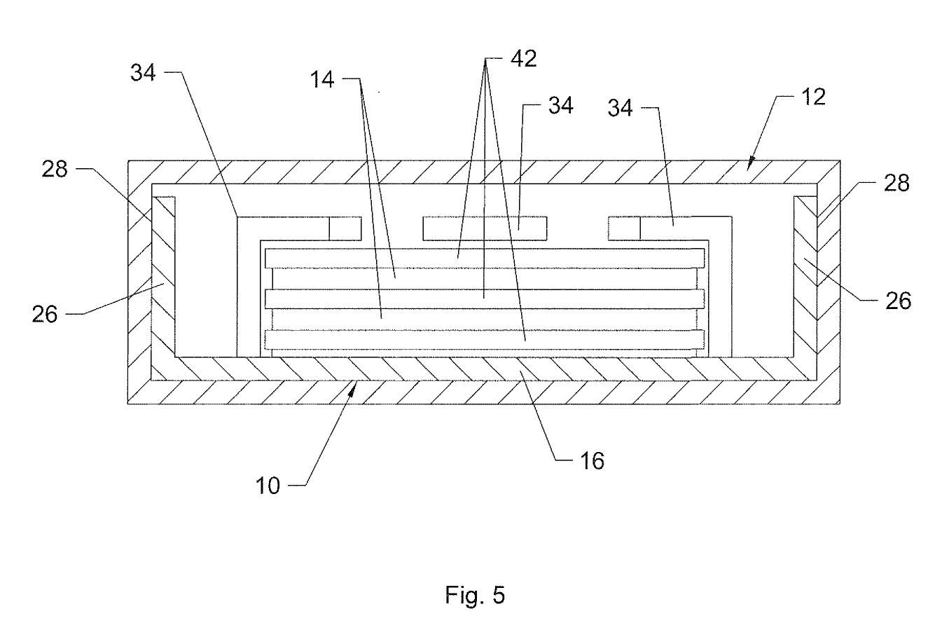

Referring to FIG. 1, the insert 10 includes a flat base or main panel member 16 that extends between four outer sidewalls 20a-d that fit snugly within an interior portion 22 of the shipping container 12. In one form, at corners 24 of the sidewalls 20a-d, a plurality of tabs 26 are provided along at least two of the opposite sidewalls 20a-d that fold vertically to extend along interior side panels 28 of the shipping container 12, such as shown in FIG. 5. Each respective tab 26 is defined by a tab fold or score line 32 that allows the tab 26 to be folded vertically upward while still being attached to the base panel member 16. In one form, the tab fold line 32 can comprise a depression, crease or perforations in the base panel member 16.

Each of the sidewalls 20a-d of the insert 10 is interrupted by a flap 34a-d that is defined and located between the corners 24 of the sidewalls 20a-d. The flaps 34a-d each have a first configuration where the flap 34a-d lies in generally planar relation to the base panel member 16 and includes an overlay portion 36 that projects outwardly from the respective adjacent sidewall to an outer end of the flap 34a-d. Each of the flaps 34a-d extends from its outer end to an inner score line 38 that is inset into the base panel member 16 from the respective adjacent sidewall 20a-d. Each of the flaps 34a-d further includes a number of score lines 40 extending across the flap 34a-d in generally parallel relation to the adjacent sidewall 20a-d. The inner score line 38 and other score lines 40 provide a number of potential folding locations for the flap 34a-d.

Referring collectively to FIGS. 1, 5 and 6, the actual score lines 38, 40 that will be folded for shipping will depend on the size, thickness and/or number of articles 42 supported by the base panel member 16. When the articles 42 are placed on the base panel member 16 for shipping, the flaps 34a-d are folded so that the overlay portion 36 of the flaps 34a-d are positioned on top of the articles 42 and extend toward one another. Each of the flaps 34a-d fold around a bottom folding location 44 provided by one of the scoring lines 38, 40 thereof that is located adjacent to the bottom edge of the articles 42 on the base member 16, and also fold around an upper scoring line 46 that is located adjacent to the top edge of the articles 42 on the base member 16 so that the overlay portion 36 of each flap 34a-d is positioned to lie on top of the articles 42. Outside edges 46 of the flaps 34a-d include cut lines 48 that allow the flaps 34a-d to bend and fold more readily. In one form, the cut lines 48 extend inwardly from the respective sidewall 20a-d toward and connect with the inner score line 38.

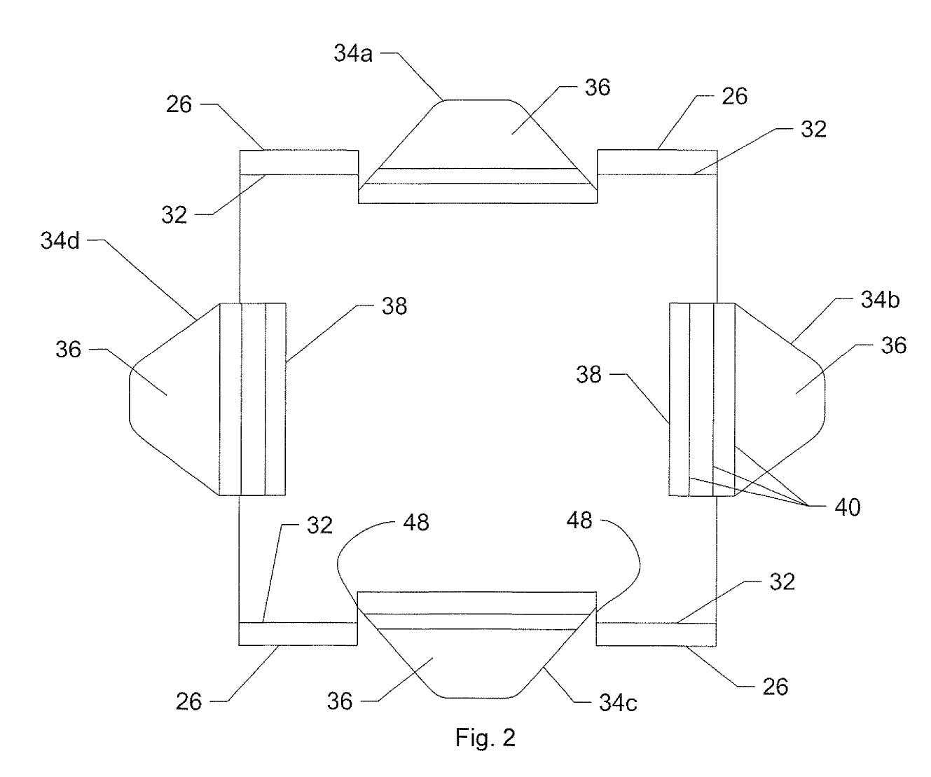

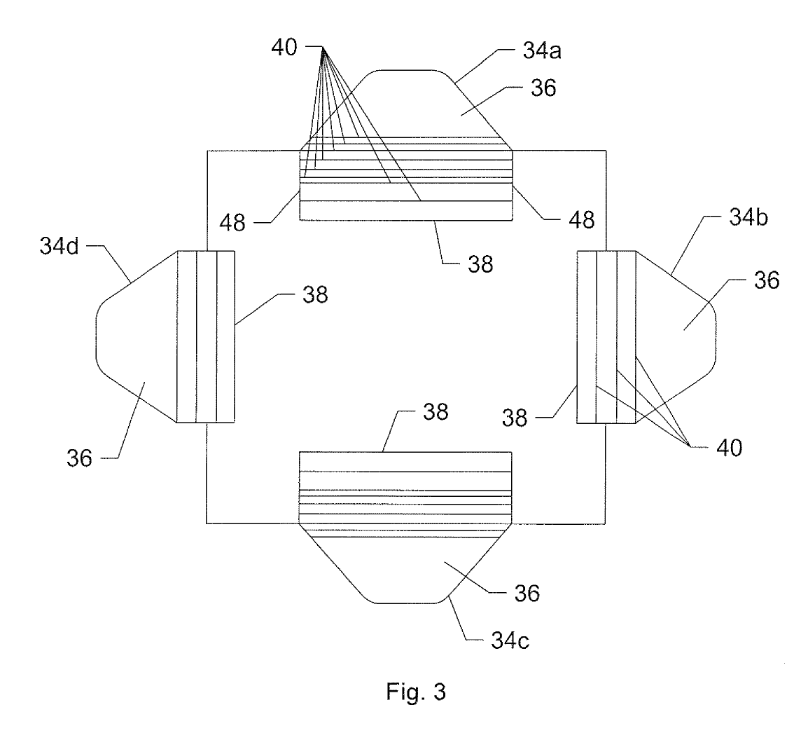

Referring to FIG. 2, another representative insert 10 is disclosed that includes several of the same features as that disclosed in FIG. 1. For the sake of brevity, a detailed description of each of the features common with the insert 10 illustrated in FIG. 1 will not be repeated. It should be appreciated by those skilled in the art that these features function in a similar manner to the features described with respect to FIG. 1. In this form, only four tabs 26 are included on the insert 10. As illustrated, the tabs 26 are positioned on opposing sidewalls 20a, 20c. Opposing sidewalls 20b, 20d do not include any tabs 26 in this representative form. It should be appreciated that any number of tabs 26 may be included on the insert 10. As illustrated in FIG. 3, in one representative form the insert 10 does not include any tabs 26.

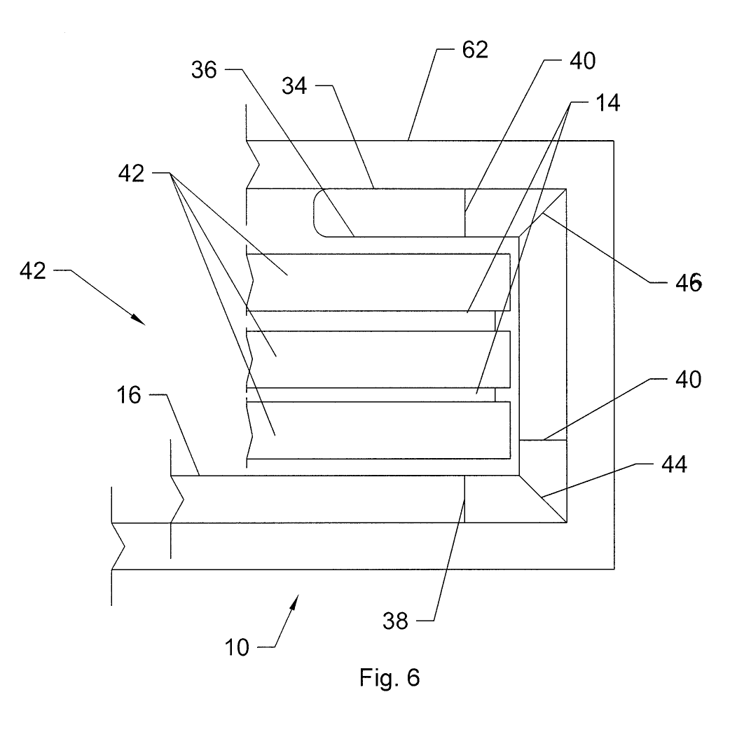

Referring to FIG. 4, one representative form of the protective insert 14 depicted in FIGS. 5 and 6 is illustrated. In this form, protective insert 14 is generally rectangular in shape and includes one or more cutouts or notches 60 that are generally rectangular in shape. It should be appreciated that the protective insert 14 as well as the notches 60 could be formed in a plurality of geometric shapes and configurations. The size and shape of the protective insert 14 can vary depending upon the configuration of the articles 42 to which they are configured to separate.

Referring to FIG. 6, in one representative form one or more straps 62 can be placed around the insert 10 to further secure the articles 14 held by the insert 10. In this form, the straps 62 are securely positioned around the insert 10 prior to the insert 10 being inserted into the container 12. In one form, the straps 62 secure the flaps 34a-d to the top of the article 42 on top of the stack of articles 42. In addition, the straps 62 force a side portion of the flaps 34a-d securely against a side surface of the articles 42. Another portion of the straps 62 is positioned against a lower surface of the base panel 16. As such, the straps 62 are wrapped around the insert 10 thereby securing the articles 42 within the insert 10. The straps 62 can be manufactured from nylon, plastic, rope, or any other type of suitable material.

In FIGS. 5 and 6, articles 42 and protective inserts 14 are shown spaced from insert 10 for the sake of clarity. It should be noted that the side edges of one or more of the articles 42 and/or protective inserts 14 may contact the adjacent flap 34a-d, the bottom-most article 42 may lie in abutting engagement with base member 16 or against a protective insert positioned between base member 16 and the bottom-most article 42, and the top-most article 42 may lie in abutting engagement with overlay portion 36 or against a protective insert positioned between overlay portion 36 and the top-most article 42.

According to one aspect, there is provided an insert 10 for a shipping container 12 where the insert 10 includes a main panel 16 having a base member forming a bottom against which articles 42 to be shipped are stacked. The main panel 16 includes four sides, and the main panel 16 includes foldable tabs 26 along at least two of the sides that fold relative to the main panel 16 to contact the inner side surface of container 12 and provide a snug fit for the insert 10 within the container 12. The insert 10 further includes foldable flaps 34a-d at each of the sides of the main panel 16. Each of the flaps 34a-d includes a plurality of scoring lines 38, 40 at or near where the flap joins the main panel 16.

The scoring lines 38, 40 each provide a fold line, where one of the scoring lines 38, 40 is selected to fold the flap 34a-d and direct a first portion of the flap away from the main panel 16 along the adjacent side of articles 42 placed on the main panel 16, and another scoring line is selected to fold a second portion 36 of the flap 34a-d relative to the first portion and direct the second portion 36 of the flap 34a-d along the uppermost one of the articles 42 placed on the main panel 16, as shown in FIG. 6. The plurality of scoring lines 38, 40 spaced along each flap 34a-d allows the selected score line for folding to vary depending on the dimensions and number of the articles 42 relative to the main panel 16 and the thickness of the articles 42 placed on the main panel 16. The fixed location of the fold line 32 of the tabs 26 allows the insert 10 to fit within and be positioned against the inner walls 28 of the shipping container 12 to prevent the articles 42 from shifting as shown in FIG. 5, even if the articles 42 shipped in the container 12 are substantially smaller than the inner dimensions of the shipping container 12.

The ability to vary the folding locations of the flaps 34a-d according to the size of the to article 42 along with the fixed fold line location of the tabs 26 allows the same insert arrangement to be used with any number of sizes of articles 42 for shipment in a commonly sized shipping container 12 since the flaps 34a-d hold the articles 42 in position relative to the insert 10 and the tabs 26 hold the insert 10 in position relative to the shipping container 12. Furthermore, the insert 10 can accommodate and securely retain varying heights of articles 42 stacked on the bottom of the insert 10 while stabilizing the articles 42 in the shipping container 12.

Another feature of the present invention discloses a method of manufacturing a storage apparatus. The method includes the step of forming a main panel 16, which may be manufactured from cardboard or other suitable packaging material. A plurality of flaps 34a-d is formed in the main panel 16 at least a portion of which extends outwardly from an outside sidewall portion of the main panel 16. A plurality of fold or score lines 38, 40 are formed in the flaps 34a-d that extend from an overlay portion 36 of the flaps 34a-d toward the main panel 16. The fold lines 38, 40 allow the flaps to wrap around at least a portion of one or more articles positioned on top of the main panel.

The present invention also discloses a method of packaging one or more articles 42, such as tile, hardwood flooring, mirrors, and other flat articles or the like. The method includes the step of placing one or more articles 42 stacked on top of one another on a main panel 16 of an insert 10. At least two opposing flaps 34a-d extending away from an outside sidewall of the main panel 16 are then bent in such a manner that an overlay portion 36 of the flaps 34a-d is proximate an upper portion of the one or more stacked articles 42 and a folding portion 38, 40 of the flaps 34a-d is proximate a side surface of the one or more articles 42. The insert 10 may then be placed within a storage container 12, such as a card board box for example, for shipment.

While the invention has been illustrated and described in detail in the drawings and foregoing description, the same is to be considered as illustrative and not restrictive in character, it being understood that all changes and modifications that come within the spirit of the invention are desired to be protected.

1. A shipping apparatus, comprising:
a main panel including a plurality of outer sidewalls and a plurality of corners, each of said outer sidewalls being located between respective adjacent ones of said corners;
at least two opposing flaps connected with said main panel at opposite ones of said plurality of outer sidewalls, said opposing flaps interrupting and extending away from said outer sidewalls between said adjacent ones of said corners, wherein said at least two opposing flaps each include an overlay portion extending from an outer end of said overlay portion toward a plurality of flap fold lines, where one of said flap fold lines connects said flap to said main panel at a location that is inset into said main panel from said outer sidewall; and
wherein said plurality of flap fold lines are configured to wrap said flaps around one or more articles such that a portion of said flap fold lines is proximate to a side surface of said article and said overlay portion is proximate an upper surface of said one or more articles.

2. The shipping apparatus of claim 1, wherein said plurality of flap fold lines are substantially parallel to one another.

3. The shipping apparatus of claim 1, further comprising one or more tabs connected with at least a portion of an outside edge of said main panel at each of said corners.

4. The shipping apparatus of claim 3, further comprising a tab fold line connecting said tabs with said outside edge of said main panel.

5. The shipping apparatus of claim 1, further comprising a protective panel configured to be positioned on a surface of said one or more articles opposite said main panel, wherein said protective panel includes at least two notches aligned with respective ones of said at least two opposing flaps when said overlay portion is proximate an upper surface of said one or more articles.

6. The shipping apparatus of claim 1, further comprising a cut line extending inwardly into said main panel a predetermined distance defining at least a portion of opposing side edges of said flaps.

7. The shipping apparatus of claim 1, further comprising a container for receiving said main panel and said at least two opposing flaps inside an internal cavity defined by said container, wherein when said flaps are folded along said one flap fold line connecting said flaps to said main panel and wrapped around said one or more articles, side portions of said flaps along sides of said one or more articles are spaced from said container and said corners contact said container in said internal cavity to provide a snug fit in said container.

8. A method of manufacturing a storage apparatus, comprising the steps of:
forming a main panel including a plurality of outer sidewalls and a plurality of corners, each of said outer sidewalls being located between respective adjacent ones of said corners;
forming a plurality of flaps at respective ones of said plurality of outer sidewalls between said adjacent ones of said corners of each of said outer sidewalls, at least a portion of each of said flaps extends outwardly from and interrupts said outer sidewall of said main panel between said corners; and
forming a plurality of fold lines extending from an overlay portion of each of said flaps toward said main panel configured to allow said flaps to wrap around at least a portion of one or more articles positioned on top of said main panel, wherein one of said flap fold lines connects said respective flap to said main panel at a location that is inset into said main panel from said respective outer sidewall.

9. The method of claim 8, further comprising the step of forming one or more tabs at outer edges of said main panel configured to bend upwardly.

10. The method of claim 9, wherein said one or more tabs are formed by placing a fold line in portions of outer edges of said main panel.

11. The method of claim 8, further comprising the step of forming a protective panel configured to be positioned on a surface of said one or more articles opposite said main panel, wherein said protective panel includes at least two notches aligned with respective ones of said at least two opposing flaps when said overlay portion is proximate an upper surface of said one or more articles.

12. The method of claim 8, further comprising the step of forming a storage container configured to receive said main panel after said one or more articles are secured in said main panel, wherein when said flaps are folded along said one fla fold line connecting said flap to said main panel and wrapped around said one or more articles, side portions of said flaps along sides of said articles are spaced from said container and said corners contact said container in said internal cavity to provide a snug fit in said container.

13. A method of packaging one or more articles, comprising the steps of:
placing one or more articles stacked on top of one another on a main panel of an insert, said main panel including an outside sidewall extending between a plurality of corners; and
bending at least two opposing flaps that are each located between adjacent ones of said plurality of corners and that each interrupt and extend away from said outside sidewall of said main panel from a fold line that is inset into said main panel from said outside sidewall such that an overlay portion of said flaps is proximate to an upper portion of said one or more stacked articles and a folding portion of said flaps is proximate to a side surface of said one or more articles and said plurality of corners of said outside sidewall of said main panel project outwardly from said folding portion of said flaps.

14. The method of claim 13, wherein said folding portion comprises a plurality of fold lines extending from an edge of said overlay portion to said main panel.

15. The method of claim 13, further comprising the step of bending one or more tabs formed along said plurality of corners of said main panel upwardly.

16. The method of claim 15, wherein said tabs are configured to extend beyond said flaps when said flaps are bent such that said overlay portion of said flaps is proximate to said upper portion of said one or more stacked articles and said folding portion of said flaps is proximate to said side surface of said one or more articles.

17. The method of claim 15, further comprising the step of inserting said insert into an interior cavity defined by a container such that said bent tabs are proximate to one or more side wall surfaces of said container and provide a snug fit of said insert and said plurality of articles in said container and said folding portions of said flaps are spaced from said side wall surfaces of said container.

18. The method of claim 13, further comprising the step of placing a strap around said insert to secure said flaps and said main panel to said one or more articles.

19. The method claim 13, further comprising the step of inserting said insert into a storage container configured to house said insert and said one or more articles, wherein said corners contact an interior surface of said container to provide a snug fit of said insert and said plurality of articles in said container and said folding portions of said flaps are spaced from said interior surface of said container.

20. A storage apparatus, comprising:
a main panel with an outer edge extending between a plurality of corners;
at least one or more tabs connected with said outer edge of said main panel at each of said corners configured to bend upwardly at a first score line; and
at least two opposing flaps between tabs of adjacent corners interrupting and extending away from said outer edge of said main panel, wherein said flaps include an overlay portion and a folding portion having a plurality of score lines, wherein said plurality of score lines are configured to bend such that said overlay portion is capable of being positioned on top of at least one article, wherein for each of said flaps one of said fold lines connects said flap to said main panel at a location inset from said outer edge of said main panel.

21. The storage apparatus of claim 20, wherein said plurality of score lines run substantially parallel to one another to a point within an interior portion of said main panel such that said one or more tabs extend beyond said point.

22. The storage apparatus of claim 20, wherein said score line comprises a perforated score line.

23. The storage apparatus of claim 20, wherein said score line comprises a compressed score line.

24. The storage apparatus of claim 20, further comprising a storage container for housing said main panel and said at least one or more tabs are bent upwardly to contact an inner wall of said storage container to provide a snug fit in said storage container when said each flaps are folded along said one fold line inset from said outer edge.

25. The storage apparatus of claim 20, further comprising a strap configured to wrap around said main panel such that said flaps are capable of being secured to said one or more articles.
